(19) United States
(12) Patent Application Publication
(10) Pub. No.: US 2013/0173833 A1
(43) Pub. Date: Jul. 4, 2013

(54) SWITCH APPARATUS SWITCHING BETWEEN BASIC INPUT OUTPUT SYSTEM CHIP AND DIAGNOSTIC CARD

(71) Applicants: HONG FU JIN PRECISION INDUSTRY (ShenZhen) CO., LTD., Shenzhen (CN); HON HAI PRECISION INDUSTRY CO., LTD., New Taipei (CN)

(72) Inventors: HUA ZOU, Wuhan (CN); CHUN-SHENG CHEN, New Taipei (TW)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/726,568

(22) Filed: Dec. 25, 2012

(30) Foreign Application Priority Data
Dec. 30, 2011 (CN) 201110451907.6

(51) Int. Cl. G06F 13/40

(52) U.S. Cl. CPC G06F 13/4022
USPC 710/301

(57) ABSTRACT

A switch apparatus which can switch between two different booting chips includes a first connector, a platform controller hub (PCH) chip, a first basic input output system (BIOS) chip, a switch circuit, and a diagnostic card. The diagnostic card includes a second connector operable to be plugged into the first connector, and a second BIOS chip. When the switch circuit receives a high level control signal from the second BIOS chip, the switch circuit outputs a high level switch signal to first and second trapping pins of the PCH chip, to select the second BIOS chip to bootstrap the motherboard. When the switch circuit does not receive a high level control signal, the switch circuit outputs a low level signal to the first and second trapping pins of the PCH chip, to select the first BIOS chip to bootstrap the motherboard.

### BACKGROUND

1. Technical Field

The present disclosure relates to an apparatus for switching a basic input output system (BIOS) chip and a diagnostic card.

2. Description of Related Art

A BIOS chip communicates with a platform controller hub (PCH) chip through a serial peripheral interface (SPI) bus. In the design period of a motherboard, a diagnostic card is employed to simulate the BIOS chip, to communicate with the PCH chip through a low pin count (LPC) bus. The diagnostic card shows the status of components, to analyze the components.

As shown in FIG. 4, the PCH chip 10 includes two strapping pins SATA1GP and GNT1. Ordinarily, when the two strapping pins SATA1GP and GNT1 are both at high voltage level, the PCH chip 10 selects the BIOS chip (not shown) of the motherboard that supports the SPI bus to bootstrap the motherboard; and when the two strapping pins SATA1GP and GNG1 are both at low voltage level, the PCH selects the BIOS chip of the diagnostic card that supports the LPC bus to bootstrap the motherboard. Actually, the strapping pin SATA1GP is coupled to a power terminal 3V through a resistor R1, and coupled to ground through a resistor R2. The strapping pin GNT1 is coupled to the power terminal 3V through a resistor R3, and coupled to ground through a resistor R4.

In debugging, the BIOS chip of the diagnostic card is needed to bootstrap the motherboard for debugging, so the resistance of the resistor R2 is far lower than the resistor R1, and the resistance of the resistor R4 is far lower than the resistor R3, making both of the two strapping pins SATA1GT and GNT1 be at low voltage level. Accordingly, the PCH chip 10 selects the BIOS chip of the diagnostic card that supports the LPC bus. However, after debugging, the BIOS chip of the motherboard that supports the SPI bus is needed to bootstrap the motherboard, the resistors R2 and R4 need to be replaced by two other resistors to put both strapping pins SATA1GT and GNT1 at a high voltage level, which is inconvenient.

Therefore, there is room for improvement in the art.

### BRIEF DESCRIPTION OF THE DRAWINGS

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

FIGS. 1, 2, and 3 are circuit diagrams of an embodiment of a switch apparatus switching between a basic input output system and a diagnostic card of the present disclosure.

FIG. 4 is a circuit diagram of a related art.

### DETAILED DESCRIPTION

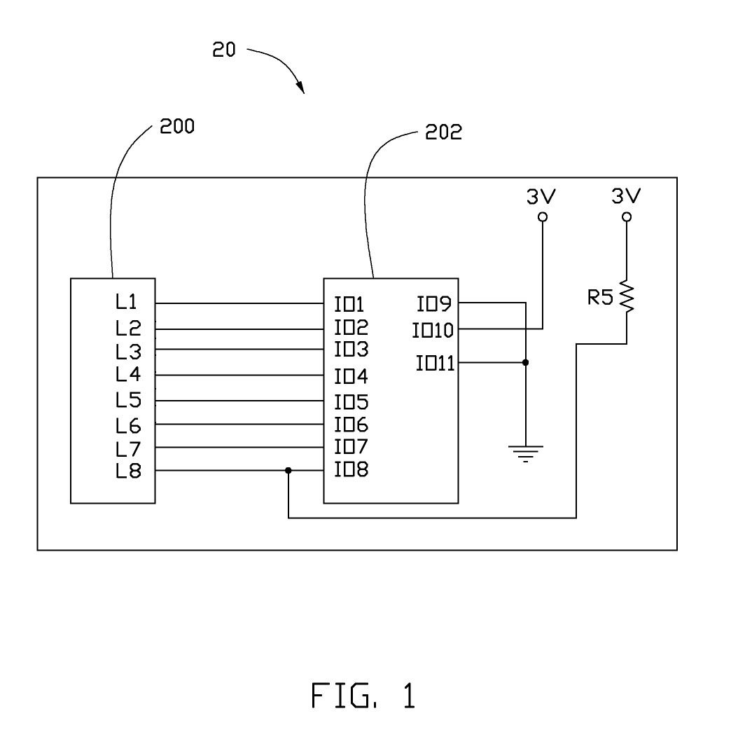

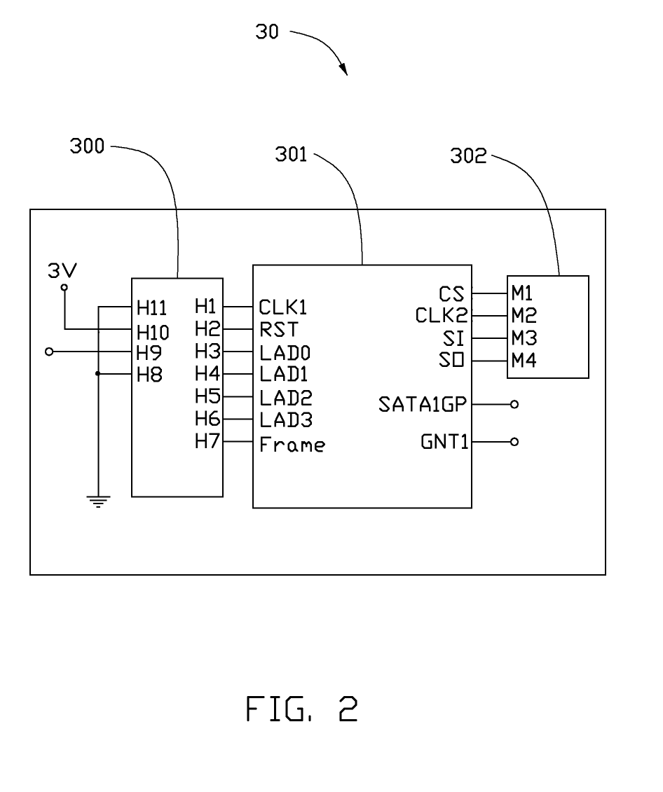

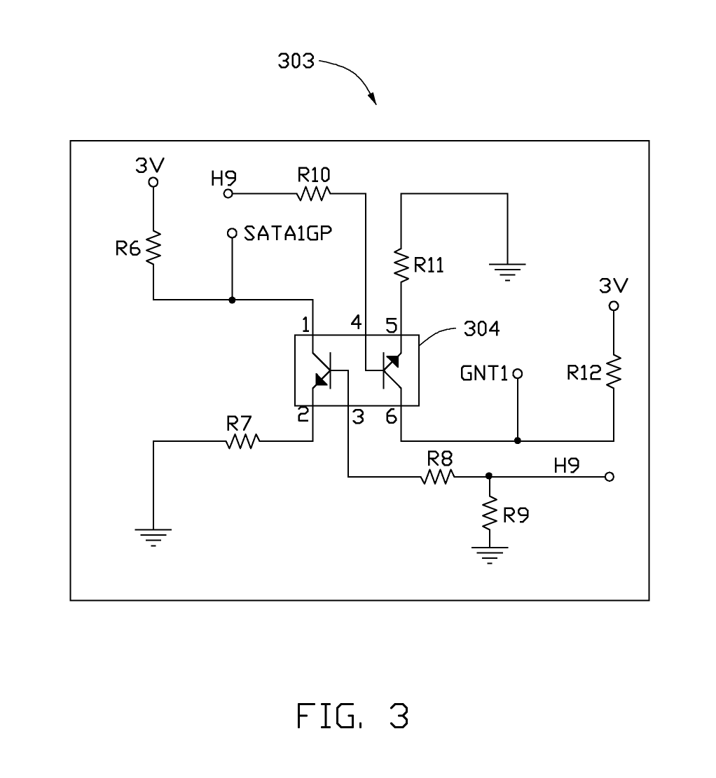

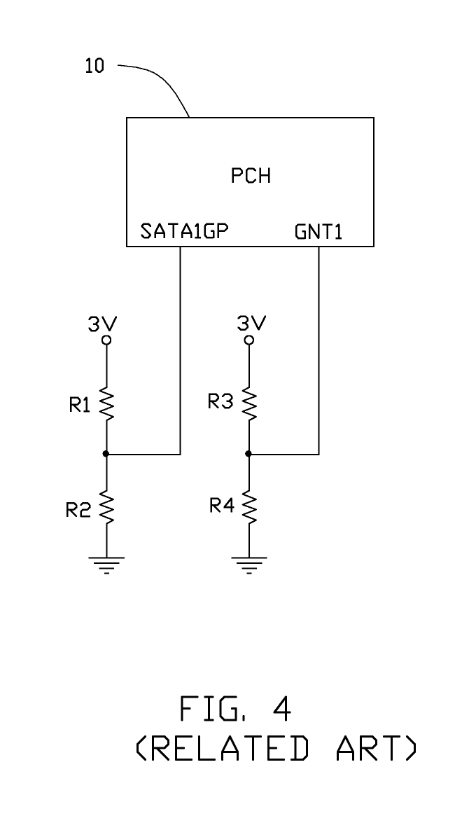

FIGS. 1 to 3 illustrate an embodiment of a switch apparatus which can switch between a first basic input output system (BIOS) chip 302 and a second BIOS chip 202 of the present disclosure. The switch apparatus includes a first connector 300, a platform controller hub (PCH) chip 301, and a switch circuit 303. The first connector 300, the PCH chip 301, the first BIOS chip 302, and the switch circuit 303 are all arranged on a motherboard 30. The second BIOS chip 202 is arranged on a diagnostic card 20.

The diagnostic card 20 further includes a second connector 200, and a resistor R5. When the motherboard 30 is in debugging mode, the second BIOS chip 202 is employed to bootstrap the motherboard 30. The second connector 200 is coupled to the second BIOS chip 202 through the low point count (LPC) bus. A pin IO1 of the second BIOS chip 202 is connected to a pin L1 of the second connector 200, to transmit a clock signal to the second connector 200. A pin IO2 of the second BIOS chip 202 is connected to a pin L2 of the second connector 200, to transmit a reset signal to the second connector 200. Pins IO3-IO6 of the second BIOS chip 202 are connected to pins L3-L6 respectively of the second connector 200, to transmit address signals to the second connector 200. A pin IO7 of the second BIOS chip 202 is connected to a pin L7 of the second connector 200, to transmit a frame signal to the second connector 200. A pin IO8 of the second BIOS chip 202 is coupled to a pin L8 of the second connector 200, and coupled to a power terminal 3V through the resistor R5, to output a high level control signal to the second connector 200. Pins IO9 and IO11 of the second BIOS chip 202 are grounded. A pin IO10 of the second BIOS chip 202 is coupled to the power terminal 3V.

The PCH chip 301 includes a first clock signal pin CLK1, a second clock signal pin CLK2, a reset pin RST, four address signal pins LAD0-LAD3, a chip select pin CS, a signal output pin SO, a signal input pin SI, a frame pin Frame, and two trapping pins SATA1GP and GNT1. Seven pins, H1-H7, of the first connector 300 are respectively coupled to the first clock signal pin CLK1, the reset pin RST, the address signal pins LAD0-LAD3, and the frame pin Frame, to receive data signals supporting the LPC protocol which are output by the PCH chip 301. When the diagnostic card 20 is plugged into the motherboard 30, that is when the second connector 200 is coupled to the first connector 300, a pin H9 of the first connector 300 is connected to the pin L8 of the second connector 200, to receive the control signal output by the pin IO8 of the second BIOS chip 202. Pins H11 and H8 of the first connector 300 are both grounded. A pin H10 of the first connector 300 is coupled to the power terminal 3V. Pins M1-M4 of the first BIOS chip 302 are respectively coupled to the chip select pin CS, the second clock signal pin CLK2, the signal input pin SI, and the signal output pin SO, to form a serial peripheral interface (SPI) bus connection.

The switch circuit 303 includes a switch chip 304, and seven resistors R6-R12. A first pin 1 of the switch chip 304 is coupled to the power terminal 3V through the resistor R6, and coupled to the trapping pin SATA1GP of the PCH chip 301. A second pin 2 of the switch chip 304 is grounded through the resistor R7. A third pin 3 of the switch chip 304 is grounded through the resistors R8 and R9, in that order. The pin H9 of the first connector 300 is coupled to a node of the resistors R8 and R9. A fourth pin 4 of the switch chip 304 is coupled to the pin H9 of the first connector 300 through the resistor R10. A fifth pin 5 of the switch chip 304 is grounded through the resistor R11. A sixth pin 6 of the switch chip 304 is coupled to the power terminal 3V through the resistor R12, and coupled to the trapping pin GNT1 of the PCH chip 301.

When the third pin 3 of the switch chip 304 receives a high level signal, the first pin 1 is electrically coupled to the second pin 2. When the fourth pin 4 of the switch chip 304 receives a high level signal, the fifth pin 5 is electrically coupled to the sixth pin 6. When the third pin 3 of the switch chip 304 receives a low level signal, the first pin 1 is disconnected from the second pin 2. When the fourth pin 4 of the switch chip 304 receives a low level signal, the fifth pin 5 is disconnected from the sixth pin 6. In the embodiment, the switch chip 304 includes two transistors. A base, an emitter, and a collector of a first transistor respectively function as the third pin 3, the second pin 2, and the first pin 1. A base, an emitter, and a collector of a second transistor respectively function as the fourth pin 4, the fifth pin 5, and the sixth pin 6.

During the process of debugging, the second connector 200 of the diagnostic card 20 is plugged into the first connector 300 of the motherboard 30. Pins L1-L8 of the second connector 200 are respectively coupled to the pins H1-H7 and H9. The pin IO8 of the second BIOS chip 202 outputs a high level control signal to the pin H9 of the first connector 300. The third pin 3 of the switch chip 304 receives the high level control signal. The first pin 1 is electrically coupled to the second pin 2, so that the first pin 1 outputs a low level signal. The fourth pin 4 receives the high level control signal. The fifth pin 5 is electrically coupled to the sixth pin 6, so that the sixth pin 6 outputs a low level signal. Accordingly, the trapping pin SATA1GP receives the low level signal from the first pin 1, and the trapping pin GNT1 receives the low level signal from the sixth pin 6. Consequently, the PCH chip 301 selects the second BIOS chip 202 for the purpose of bootstrapping the motherboard 30, to debug the motherboard 30.

After the process of debugging, the diagnostic card 20 is removed from the motherboard 30. The second connector 200 is disconnected from the first connector 300. The pin H9 of the first connector 300 will no longer receive the high level control signal from the pin IO8 of the second connector 200. The third 3 and fourth 4 pins are both at low level, so that the first pin 1 is disconnected from the second pin 2, and the fifth pin 5 is disconnected from the sixth pin 6. Accordingly, the trapping pins SATA1GP and GNT1 will receive high level signals. Consequently, the PCH chip 301 will select the first BIOS chip 302 for the purpose of bootstrapping the motherboard 30.

While the disclosure has been described by way of example and in terms of preferred embodiments, the disclosure is not limited thereto. On the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A switch apparatus, comprising:
a first connector arranged on a motherboard;
a platform controller hub (PCH) chip arranged on the motherboard and coupled to the first connector through a low pin count (LPC) bus, the PCH chip comprising a first trapping pin and a second trapping pin;
a first basic input output system (BIOS) chip arranged on the motherboard, and coupled to the PCH chip through a serial peripheral interface (SPI) bus;
a switch circuit arranged on the motherboard; and
a diagnostic card, comprising:
a second connector being detachably plugged into the first connector; and
a second BIOS chip coupled to the second connector, to output a high level control signal through the second connector;
wherein the switch circuit receives the high level control signal from the second BIOS chip through the first connector in response to the second connector being plugged into the first connector, the switch circuit outputs high level switch signals to the first and second trapping pins of the PCH chip, to select the second BIOS chip to bootstrap the motherboard; wherein the switch circuit does not receive the high level control signal in response to the second connector not being plugged into the first connector, the switch circuit outputs low level signals to the first and second trapping pins of the PCH chip, to select the first BIOS chip to bootstrap the motherboard.

2. The switch apparatus of claim 1, wherein first to eighth pins of the second connector are coupled to first to eighth pins of the second BIOS chip, respectively, ninth and eleventh pins of the second BIOS chip are grounded, a tenth pin of the second BIOS chip is coupled to a power terminal, the eighth pin of the second BIOS chip is coupled to the power terminal through a first resistor, to output the high level control signal.

3. The switch apparatus of claim 1, wherein first to seventh pins of the first connector are coupled to first to seventh pins of the PCH chip, respectively, eighth and eleventh pins of the first connector are grounded, a tenth pin of the first connector is coupled to a power terminal, a ninth pin of the first connector receives the high level control signal from the second BIOS chip in response to the second connector being plugged into the first connector, eighth to eleventh pins of the PCH chip are coupled to first to fourth pins of the first BIOS chip, respectively.

4. The switch apparatus of claim 3, wherein the switch circuit comprises a switch chip, a first pin of the switch chip is coupled to the first trapping pin of the PCH chip, a second pin of the switch chip is grounded, third and fourth pins of the switch chip are coupled to the ninth pin of the first connector, a fifth pin of the switch chip is grounded, a sixth pin of the switch chip is coupled to the second trapping pin of the PCH chip, the first and sixth pins of the switch chip are also coupled to the power terminal through first and second resistors, respectively; when the third pin of the switch chip receives a high level signal, the first pin of the switch chip is connected to the second pin of the switch chip to output the low level switch signal to the first trapping pin; when the fourth pin of the switch chip receives a high level signal, the sixth pin of the switch chip is connected to the fifth pin of the switch chip to output the low level switch signal to the second trapping pin of the PCH chip.

5. The switch apparatus of claim 4, wherein the second pin of the switch chip is grounded through a third resistor.

6. The switch apparatus of claim 5, wherein the third pin of the switch chip is grounded through a fourth resistor and a fifth resistor in that order, and a node between the fourth resistor and the fifth resistor is coupled to the ninth pin of the first connector.

7. The switch apparatus of claim 6, wherein the fifth pin of the switch chip is grounded through a sixth resistor.

8. The switch apparatus of claim 7, wherein the fourth pin of the switch chip is coupled to the ninth pin of the first connector through a seventh resistor.
